(19) United States
(12) Patent Application Publication
(10) Pub. No.: US 2004/0202988 A1
(43) Pub. Date: Oct. 14, 2004

(54) Human capital management assessment tool system and method

(76) Inventors: Michael A. Evans, Indianapolis, IN (US); Daniel M. Snively, Indianapolis, IN (US)

Correspondence Address: BAKER & DANIELS, 300 NORTH MERIDIAN STREET, SUITE 2700, INDIANAPOLIS, IN, 46204-1782, US

(21) Appl. No.: 10/823,829

(22) Filed: Apr. 14, 2004

Related U.S. Application Data
(60) Provisional application No. 60/462,619, filed on Apr. 14, 2003.

(51) Int. Cl. G09B 3/00; G09B 7/00

(52) U.S. Cl. 434/236

(57) ABSTRACT

The present invention involves an analytical method of providing human capital management in an organization which includes a plurality of individuals. The method involves the steps of: providing individual capability tests each having a plurality of questions; obtaining responses to the questions from the individual to be evaluated; and cross-referencing the questions according to a predetermined criteria to create a comprehensive individual capability evaluation. The cross-referencing step includes creating one or more hallmark analysis within the comprehensive individual capability evaluation, each hallmark analysis relating to a specific quality of the individual. The predetermined criteria relates to one of the set of personality attributes including: Integrity, Continuous Learning, Speed/Initiative, Energized Team-building, Quality/Customer Oriented, Extraordinary Results, Effective Communication, Financial Literacy, Strategic Focus, and Emotional Maturity. The method further comprises the step of creating an individual action plan containing a listing of transformational activities for enabling the individual to improve identified areas on the comprehensive individual capability evaluation.

### BACKGROUND OF THE INVENTION

1. Field of the Invention

The invention relates to management of business organizations. More specifically, the field of the invention is that of human resource systems for business management planning and implementation.

2. Description of the Related Art

Human resource systems generally attempt to place individuals into jobs to which they are best suited within an organization. For example, in a factory there may be job positions which require physical strength, manual dexterity, and repetitive motions. Human resource systems may be implemented so that the stronger individuals are assigned the job positions requiring physical strength, more dexterous individuals are assigned the job positions requiring manual dexterity, and more agile individuals are assigned the job positions requiring repetitive motions. While there are fairly well defined metrics to measure and assess workers physical skills relative to job requirements, measurement and assessment of an individual's non-physical capabilities is less developed.

Several mental capability tests are known which assess and evaluate competencies of individuals in many non-physical domains. For example, the Manchester personality questionnaire is an occupational personality test that focuses on traits relevant to creative and innovative behavior. Also, the WPQ Emotional Intelligence questionnaire is based on a conceptual model of emotional intelligence that has seven components: innovation, self-awareness, intuition, emotions, motivation, empathy, social skills. Another test, the Watson-Glaser critical thinking appraisal, is an assessment tool designed to measure an individual's critical thinking skills in five components: inference, recognition of assumptions, deduction, interpretation, and evaluation of arguments. For other capabilities, the PASAT 2000 report is a rigorously constructed questionnaire designed to assess personality attributes that are vital to success in a sales environment, and measures eight main components: social adjustment, motivational adjustment, emotional adjustment, adaptability, conscientiousness, social control, emotional stability, and self-assurance.

While the above identified prior art tests and other known systems provide limited insights into the potential performance of individuals, they lack a comprehensive evaluation of the individual's capabilities and potential.

### SUMMARY OF THE INVENTION

The present invention provides a human capital management tool that cross-references several testable competencies of individuals to provide a capabilities assessment and implementation plan for human capital management. The invention utilizes several validated capabilities tests, culling selected data relating to several capabilities rated from the validated tests, and providing a comprehensive evaluation of the individual's capabilities. From this evaluation, both a comparative measurement of relevant skills and a notation of areas for development and improvement are provided to the individual. Thus, individuals may be more comprehensively and thoroughly evaluated, and human capital management is enabled to provide further training to enhance an individual's expected performance.

The present invention provides a relative rating of several individual capabilities thus allowing for more effective assessment, more focused analysis of improvement areas, and thus providing a planning tool to create capability enhancement plans for the individual.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a flow chart view of the methodology of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of analysis algorithms and symbolic representations of operations. These analysis algorithms may be practiced without the aid or assistance of computers, however in the following description the invention shall be described as being implemented on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps may require physical manipulations of physical quantities, or the implementation of actions based on ideas and/or teachings (qualities). Usually, though not necessarily, these quantities and qualities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and qualities, and are merely used here as convenient labels applied to these quantities and qualities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired results, and which may also be practiced within a business organization as a method of doing business.

The present invention also relates to a system for performing these operations. This system may be specifically constructed for the required purposes or it may comprise a general purpose computer as selectively activated or reconfigured by a computer program stored in the computer. The algorithms presented herein are not inherently related to any particular computer or other apparatus, and may be implemented by a business organization without any computers at all. In particular, various general purpose machines may be used with programs written in accordance with the teachings herein, or it may prove more convenient to construct more specialized apparatus to perform the required method steps, or the business organization may be implemented to perform the required method steps. The required structure for a variety of these machines and organizations will appear from the description below. The description also uses some terminology relating to human capital management that need to be clarified in the paragraph below.

Human Capital Management involves assessing the competencies and characteristics of individuals in an organization, evaluating the strengths and weaknesses of those individuals, and providing planning for further training and experience to aid those individuals in improving their performance and capabilities.

Leadership Talent is comprised of character, intrinsic gifts, drive, personality, competencies, skills, attitudes, experiences, instincts and judgement. While these qualities may have some degree of subjective evaluation, all of these qualities may be measured by objective tests. The methodology of the present invention reconciles these various qualities in a comprehensive statistical evaluation of individuals.

Assessment Instruments are tests that have been validated by statistical sampling, typically provided by third party organizations to measure specific aspects of Leadership Talent. Using proven and validated Assessment Instruments to provide data for the comprehensive evaluation of the present invention allows the invention's modeling to be implemented without requiring extensive statistical validation as the Assessment Instruments are independently evaluated prior to being selected for use with the methodology of the present invention.

Hallmarks Analysis relates to the specific analysis for a particular aspect of Leadership Talent. A weighted average of responses to selected questions in the Assessment Instruments is one method of performing a Hallmark Analysis, alternatively a formulaic combination of responses to selected questions in the Assessment Instruments is another way to accomplish this analysis.

Transformational Outcomes relate to action items that the individual may engage in to help to improve aspects of Leadership Talent which are indicated by the analysis of the Assessment Instruments using the methodology of the present invention. Action items may include tasks, responsibilities, goals, and deadlines to facilitate personal growth to improve the identified aspects of Leadership Talent. The Transformational Outcomes are selected based on the comprehensive evaluation of the results of the Assessments Instruments.

The present invention provides an analytical method of providing human capital management information, for particular individuals or for general personnel management of an organization. Individuals complete Assessment Instruments which provide an initial source of data. While there are several different known Assessment Instruments, no single Assessment Instrument is designed or capable of providing a comprehensive evaluation of several relatively unrelated aspects of Leadership Talent or related skills. A realization of the inventors of the present invention is that a comprehensive evaluation may be obtained by selectively processing distinct questions or sections of existing Assessment Instruments. By selecting certain portions to obtain data relevant to particular aspects of Leadership Talent, its several aspects can be evaluated using validated tests and more comprehensive conclusions can be formulated from the results of the several tests than in any single Assessment Instrument. The invention realizes that a single Assessment Instrument is probably incapable of obtaining significant data on all aspects of Leadership Talent, and cross-references data from Assessment Instruments to obtain data relevant to such a comprehensive evaluation.

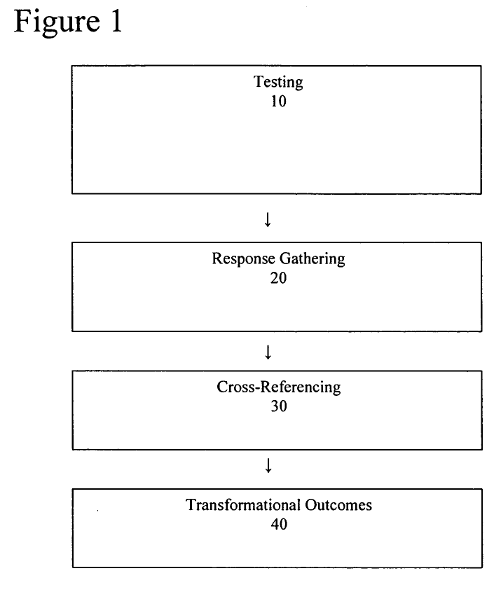

The flow chart diagram of FIG. 1 generally shows the methodology of the present invention. In testing step 10, a plurality of individual capability tests (or “battery”) are administered to the individual, each test having a plurality of questions. The next step, response gathering step 20 involves obtaining responses to the plurality of questions from the individual to be evaluated. With this information, an evaluator or a computer may proceed with cross-referencing step 30 which cross-references the responses to the several questions administered in testing step 10 according to a predetermined criteria (as described more fully below) to create a comprehensive individual capability evaluation. Cross-referencing step 30 may further include creating a plurality of hallmark analysis within the comprehensive individual capability evaluation. Each hallmark analysis relating to a specific quality of the individual. Transformational outcomes step 40 next involves creating an individual action plan containing a listing of transformational activities for enabling the individual to improve identified areas on the comprehensive individual capability evaluation.

Instruments considered for a battery relate to individual capabilities that meet a specific focus of the intended Hallmark evaluation. Selection of the instruments for the battery is determined by the type, scope, functionality, overall accuracy and fit with the assessment design and substance of the Hallmark battery being constructed. The battery may be administered by a personal interview, a paper questionnaire, an interactive computer program or other conventional method. The actual method used to administer a battery is selected according to the efficiency and accuracy standards needed by the evaluating organization. Administering instruments by a computer program, particularly a computer program accessed over a telecommunications network such as the Internet, makes the administration and collection of response data particularly efficient. Suitable instruments for the exemplary embodiment of the invention include: the Manchester Personality Questionnaire; the Work Profile Questionnaire-Emotional Intelligence; the PASAT 2000 Report (Manchester Personality Questionnaire, Work Profile Questionnaire-Emotional Intelligence, and PASAT 2000 Report are trademarks of The Test Agency Ltd. of Cray House, Woodlands Road, Henley-on-Thames, Oxon, RG9 4AE, United Kingdom); and/or the Watson-Glaser critical thinking appraisal (Watson-Glaser Critical Thinking Appraisal is a trademark of The Psychological Corporation of 19500 Bulverde Road, San Antonio, Tex. 78259, USA).

Capabilities may include a plurality of individual characteristics. In the exemplary embodiment dealing with capabilities relating to leadership, the following capabilities or competencies, inter alia, are relevant: Integrity, Continuous Learning, Speed/Initiative, Energized Team-building, Quality/Customer Oriented, Extraordinary Results, Effective Communication, Financial Literacy, Strategic Focus, and Emotional Maturity. A battery of tests are identified that have questions that relate to one or more of these capabilities.

In the exemplary embodiment of the invention, the Hallmarks battery is administered to a client upon receipt of the e-mail address of the person taking the assessments. A personally addressed e-mail is sent to the respondent describing the assessment process, providing instructions for taking the instruments and inserting a secure, coded hyperlink direct to the respondent's personal battery. The e-mail message also provides the respondent a due date for completion of the assessments and issues the Test Administrator's name, email address and phone number for the respondent to contact a live helpline should complications occur. The respondent may use the hyperlink to activate the web pages containing the battery, and the respondent interacts with the web pages to provide responses to the several questions of the battery. The host of the web pages records the responses and may process those responses itself or send the responses to another location for processing.

Once the responses, or assessment results, have been received, the processing center responsible for the Hallmarks report sorts through the raw scores from the assessment battery and maps selected scored attributes to a pre-coded value statement either electronically (through a completely automated electronic process or a semi-automatic electronic process where information is manually entered into a database and a program scores the information) or manually (where all tabulations are done by hand) that has been designated to a specific Hallmark. This process continues until each of the attributes has been mapped to its respective Hallmark.

For example, one Hallmark is Strategic Focus and will serve as an example of how different assessed attributes from the battery of Instruments is used to construct a quantifiable competency rating. Five attributes from different Assessment Instruments are selected that are associated with the identified competency. In the example of Strategic Focus, the attributes of Assertiveness, Creativity, Strategy, Motivation and Innovation are selected from the Manchester Personality Questionnaire 14.2 (MPQ14.2), Personal Competency Inventory (PCI) and Work Profile Questionnaire emotional intelligence (WPQei) respectively. Each of the attributes is measured by statements in the respective instruments that a respondent answers according to the options the question provides. The respondent's answer is given a numeric value that is compiled with all of his/her answers to the questions posed in the Instrument. An exploded view for each of attributes associated with the Hallmark Strategic Focus is provided with questions from each respective assessment instrument.

Attributes Assertiveness and Creativity from the MPQ14.2 are represented with the following instructions and associated questions. “This questionnaire contains statements about how you act, think or feel in different situations. Please indicate the extent to which each statement applies to you, using the rating scale shown below.”

| | | | | |
|---|---|---|---|---|
| A | B | C | D | E |
| Never | Occasionally | Fairly Often | Generally | Always |

Assertiveness
“I argue my own point of view”

| | | | | |
|---|---|---|---|---|
| A | B | C | D | E |

“I express my views even when I know people won't like what I say”

| | | | | |
|---|---|---|---|---|
| A | B | C | D | E |

“I am forceful and assertive”

| | | | | |
|---|---|---|---|---|
| A | B | C | D | E |

Creativity
“I like to let my imagination run free”

| | | | | |
|---|---|---|---|---|
| A | B | C | D | E |

“I am keen to try new approaches”

| | | | | |
|---|---|---|---|---|
| A | B | C | D | E |

“I am a person who originates changes”

| | | | | |
|---|---|---|---|---|
| A | B | C | D | E |

Attributes Strategy and Motivation from the PCI are represented with the following instructions and associated questions. “The PCI asks respondents to consider four competency items. First choose the item you consider you perform most effectively and rank it as a 4 and then the item that you consider you perform least effectively and rank it as a 1. Next, rank the remaining two items in terms of personal effectiveness, one as a 3 and the other as a 2.”

Strategy

| Strategy | | | | |
|---|---|---|---|---|
| “Recovering quickly from upsets” | 1 | 2 | 3 | 4 |
| “Strategic Thinking” | 1 | 2 | 3 | 4 |
| “Sharing the organization's purpose” | 1 | 2 | 3 | 4 |
| “Procurement planning” | 1 | 2 | 3 | 4 |
| “Building project teams” | 1 | 2 | 3 | 4 |
| “Asking for help” | 1 | 2 | 3 | 4 |
| “Initiating change” | 1 | 2 | 3 | 4 |
| “Scenario planning” | 1 | 2 | 3 | 4 |
| “Seeing the bigger picture” | 1 | 2 | 3 | 4 |
| “Collaborating with people” | 1 | 2 | 3 | 4 |
| “Finding ways of reducing costs” | 1 | 2 | 3 | 4 |
| “Involving people in decision making” | 1 | 2 | 3 | 4 |
| Motivation | | | | |
| “Cutting through red tape” | 1 | 2 | 3 | 4 |
| “Seizing opportunities” | 1 | 2 | 3 | 4 |
| “Delighting customers” | 1 | 2 | 3 | 4 |
| “Watching costs” | 1 | 2 | 3 | 4 |
| “Persisting despite setbacks” | 1 | 2 | 3 | 4 |
| “Winning business” | 1 | 2 | 3 | 4 |
| “Finding ways of relaxing” | 1 | 2 | 3 | 4 |
| “Practicing new skills” | 1 | 2 | 3 | 4 |
| “Getting things done” | 1 | 2 | 3 | 4 |
| “Being sensitive and understanding” | 1 | 2 | 3 | 4 |
| “Searching for information on the web” | 1 | 2 | 3 | 4 |
| “Delegating roles and responsibilities” | 1 | 2 | 3 | 4 |

The final attribute Innovation from the WPQei is represented with the following instructions and associated questions. “This questionnaire contains statements about how you act, think or feel in different situations. Please indicate the extent to which each statement applies to you, using the rating scale shown below.”

| | | | | |
|---|---|---|---|---|
| A | B | | D | E |
| Always/Almost | Very | C | From time to | Never/Almost |
| Always | Often | Fairly Often | time | Never |

Innovation
“I have generated novel ideas about how to do things differently”

| | | | | |
|---|---|---|---|---|
| A | B | C | D | E |

“I have shown a flair for working on innovative projects”

| | | | | |
|---|---|---|---|---|
| A | B | C | D | E |

“I have been reluctant to challenge the status quo”

| | | | | |
|---|---|---|---|---|
| A | B | C | D | E |

After the collection and scoring of attributes for a Hallmark has been completed, the respective competencies have been identified and defined with the selected Assessment Instruments, and the narrative report is written. The specific questions in each of the Assessment Instruments may not be in order or particularly identified as being associated with the attribute. Each Hallmark Analysis uses assigned selected competencies that have been determined to be the most suitable for each Hallmark from the total number of competencies represented from the battery of instruments. Each selected competency for a Hallmark is coded with a graduated value (e.g. 1-3=low, 4-7=average, 8-10=high) then averaged to provide a mean score for the Hallmark Analysis report.

Upon completion of a Hallmarks Analysis, content experts in the specific areas being assessed review the draft product for edit accuracy and assessment relevance to the report's target audience. High performers with a proven track-record expertise and performance are administered the battery to statistically determine competency accuracy, assessment relevance and Instrument validation. As the Instrument is administered, results from other proven high performers are used to conduct criterion and construct studies to provide validation to improve the effectiveness of the assessment findings. Continued research, assessment and results from applied coaching provide feedback to calibrate the Instrument's effectiveness in fulfilling its intent. By monitoring such high performers, the scoring criteria and selection of Instruments, individual questions, and relevant attributes may be modified to reflect the most current data.

The Hallmark Analysis report is written by integrating the research findings, Instrument assessments and value-coded statements representing the selected competencies from the Assessment Tools. A composite scale from all of the Instruments is provided to catalog the raw scores from each of the Instruments. This compilation of the raw scores in conjunction with the scoring of the Hallmark Analysis is used to present additional findings. Each Hallmark has a corresponding Transformation Outcome that is determined by a pre-coded score (1-4 out of 10) on a selected competency that most succinctly measures the success of the Hallmark. Each of the Transformation Outcomes is presented at the end of the Hallmark narrative to assist anyone who wants to strengthen an area of expertise in spite of their score. In addition, each Hallmark Analysis report contains the assessment report for each Instrument used in the battery to further assist the respondent's quest for self-improvement.

The goal of each Hallmark Analysis is to apply the assessment findings to promote professional and personal development (e.g. leadership, management, sales, etc.) Selected batteries are used to provide a comprehensive analysis from multiple assessment perspectives formulated to individual attributes that characterize excellence in the field being assessed. Each Hallmark has an associated Transformational Outcome that is triggered for development attention when a score is registered within a designated range. This feature provides a specific training path initiated by the assessment results. The Transformation Outcome may also be influenced by other assessments created during the Hallmark Analysis.

The training and development path may have up to six steps. First, the assessment battery is administered by the assessment center and completed by the respondent. Second, the assessment results are compiled and translated into the specific, customized computer codes of a specific Hallmark assessment Instrument. Third, the respondent or client receives and reads the Hallmark Analysis report and individual assessment Instrument reports, noting observations and questions. Fourth, an interpretation of the Hallmark Analysis reports is provided to assist the client in understanding the findings and their relationship to a prescribed training path suggested by the findings. Fifth, the client evaluates the findings compared to current challenges and concludes with an advisor the most critical areas for focused development. Sixth, a personal development plan is developed with the client and an advisor utilizing resources, exercises and assignments from the client's organization and/or the CHORUS Assessment Center™. (Assessment Center is a trademark of Chorus, Inc. of Indianapolis, Ind.)

When the battery is administered, typically several Hallmark Analysis may be created based on the responses provided by the individual. The present invention also may be used in developing an assessment strategy for enterprises that can incorporate a custom-designed Hallmark Analysis to fit their culture and/or specific desired objectives. Various methods are used to assist the enterprise in maximizing the development experience including coaching, e-learning, practice, Internet searches, using their existing training resources, etc.

The present invention may also be implemented and utilized by an interactive web-based management vehicle. Participating individuals may take batteries and have access to their personal assessment information through a highly secure Application Service Provider (ASP) web portal. This interactive portal facilitates participants' ability to review their personalized development plans and take advantage of custom learning experiences. Participants may evaluate development progress on an ongoing basis and utilize point-in-time query capabilities. Registration for seminars and workshops as Transformative Outcomes may be handled through the same portal, as well as the ordering of reference material pertaining to the developmental needs identified by the assessment. Online training programs, white papers, journal articles and even databases specifically designed for education, personal and professional development may also be accessible via the portal. Ongoing program management may include the sharing of best practices from programs and initiatives within the sphere of the Participants. Given the constraints on many individual's schedules, the portal may include distance-learning opportunities that are readily and easily available. An extensive bank of web-based training programs related to Transformative Outcomes allows Participants to benefit from results-based professional development programs online. Also, Participants may have the opportunity to participate in online, real time forums focused on specific program topics related to a Transformative Outcome. Subject matter available to Participants may range from course work on specific educational issues with a Transformative Outcome, to more global areas of Leadership Skills. The same assessment and development resources used by individual Participants may also be applied to teams of individuals from a common organization. Research findings are clear in their evidence that opportunities for team involvement are an essential component of effective implementation of change strategies.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An analytical method of providing human capital management information, said method comprising the steps of:
providing a plurality of individual capability tests, the individual capability tests each having a plurality of questions;
obtaining responses to the plurality of questions of each of the plurality of individual capability tests from the individual to be evaluated; and
cross-referencing the questions according to a predetermined criteria to create a comprehensive individual capability evaluation.

2. The method of claim 1 wherein said cross-referencing step includes creating a plurality of hallmark analysis within the comprehensive individual capability evaluation, each one of the plurality of hallmark analysis relating to a specific quality of the individual.

3. The method of claim 1 wherein said predetermined criteria relates to one of the set of personality attributes including: Integrity, Continuous Learning, Speed/Initiative, Energized Team-building, Quality/Customer Oriented, Extraordinary Results, Effective Communication, Financial Literacy, Strategic Focus, and Emotional Maturity.

4. The method of claim 1 further comprising the step of creating an individual action plan containing a listing of transformational activities for enabling the individual to improve identified areas on the comprehensive individual capability evaluation.

5. A computer server for providing human capital management information across a computer network, said computer server comprising:
means for providing a plurality of individual capability tests, the individual capability tests each having a plurality of questions;
means for obtaining responses to the plurality of questions of each of the plurality of individual capability tests from the individual to be evaluated; and
means for cross-referencing the questions according to a predetermined criteria to create a comprehensive individual capability evaluation.

6. The computer server of claim 5 wherein said cross-referencing means includes means for creating a plurality of hallmark analysis within the comprehensive individual capability evaluation, each one of the plurality of hallmark analysis relating to a specific quality of the individual.

7. The computer server of claim 5 wherein said predetermined criteria used by said cross-referencing means relates to one of the set of personality attributes including: Integrity, Continuous Learning, Speed/Initiative, Energized Team-building, Quality/Customer Oriented, Extraordinary Results, Effective Communication, Financial Literacy, Strategic Focus, and Emotional Maturity.

8. The computer server of claim 5 further comprising means for creating an individual action plan containing a listing of transformational activities for enabling the individual to improve identified areas on the comprehensive individual capability evaluation.

9. In a computer, a method of providing human capital management information, said method comprising the steps of:
providing a plurality of individual capability tests, the individual capability tests each having a plurality of questions;
obtaining responses to the plurality of questions of each of the plurality of individual capability tests from the individual to be evaluated; and
cross-referencing the questions according to a predetermined criteria to create a comprehensive individual capability evaluation.

10. The computer method of claim 9 further comprising the step of creating an individual action plan containing a listing of transformational activities for enabling the individual to improve identified areas on the comprehensive individual capability evaluation.

11. The computer method of claim 9 wherein said predetermined criteria relates to one of the set of personality attributes including: Integrity, Continuous Learning, Speed/Initiative, Energized Team-building, Quality/Customer Oriented, Extraordinary Results, Effective Communication, Financial Literacy, Strategic Focus, and Emotional Maturity

12. The computer method of claim 9 wherein said cross-referencing step includes creating a plurality of hallmark analysis within the comprehensive individual capability evaluation, each one of the plurality of hallmark analysis relating to a specific quality of the individual.

13. The computer method of claim 9 wherein said providing step includes using an interactive computer server accessible over a computer network.
